(19) United States
(12) Patent Application Publication
(10) Pub. No.: US 2026/0170871 A1
(43) Pub. Date: Jun. 18, 2026

(54) METHOD AND APPARATUS FOR BEHAVIOR RECOGNITION BASED ON VIRTUAL REGION OF INTEREST

(71) Applicant: SK TELECOM CO., LTD., Seoul (KR)

(72) Inventors: Chun Fei MA, Seoul (KR); Young Chul YOON, Seoul (KR); Byeong Won LEE, Seoul (KR); Jin Seong JANG, Seoul (KR)

(21) Appl. No.: 19/532,080

(22) Filed: Feb. 6, 2026

Related U.S. Application Data
(63) Continuation of application No. PCT/KR2024/011731, filed on Aug. 7, 2024.

(30) Foreign Application Priority Data
Oct. 23, 2023 (KR) 10-2023-0141737

(51) Int. Cl. G06V 40/20; G06V 10/25

(52) U.S. Cl. CPC G06V 40/20; G06V 10/25

(57) ABSTRACT

A method and apparatus for behavior recognition based on a virtual region of interest is disclosed. One aspect of the present disclosure provides a computer-implemented method for recognizing behavior of an object, the computer-implemented method including detecting an object from an image; generating a virtual region of interest based on a region in which the object is detected; and determining whether the object is exhibiting a predetermined type of behavior based on an area of an overlapping region between the detected object region and the virtual region of interest.

### CROSS-REFERENCE TO RELATED APPLICATION

This application is a continuation of International Application No. PCT/KR2024/011731, filed Aug. 7, 2024, which is based upon and claims priority to Korean Patent Application No. 10-2023-0141737 filed on Oct. 23, 2023. The entire disclosures of the above applications are incorporated herein by reference.

### TECHNICAL FIELD

The present disclosure relates to a method and apparatus for behavior recognition based on a virtual region of interest.

### BACKGROUND

The content described hereinafter merely provides background information on this embodiment and does not constitute the prior art.

With the recent development of IT technology, research on technologies for recognizing an object's behavior or a situation surrounding the object from an image captured by a camera is being actively conducted. Techniques for recognizing the object's behavior from the image mainly utilize an algorithm based on an artificial intelligence model. To train the artificial intelligence model to recognize a specific behavior, a large amount of training data is required, and constructing the training data and training consume significant cost and time. When the trained model is applied to environments different from those of the training data, its generalization performance degrades severely.

### SUMMARY

At least one aspect of the present disclosure provides a computer-implemented method for recognizing behavior of an object, the computer-implemented method including detecting an object from an image; generating a virtual region of interest based on a region in which the object is detected; and determining whether the object is exhibiting a predetermined type of behavior based on an area of an overlapping region between the detected object region and the virtual region of interest.

Another aspect of the present disclosure provides an apparatus including a memory configured to store instructions; and at least one processor, wherein the at least one processor executes the instructions to: detect an object from an image; generate a virtual region of interest based on a region in which the object is detected; and determine whether the object is exhibiting a predetermined type of behavior based on an area of an overlapping region between the detected object region and the virtual region of interest.

Yet another aspect of the present disclosure provides a non-transitory computer-readable recording medium storing instructions that, when executed by a computer, cause the computer to execute: a process of detecting an object from an image; a process of generating a virtual region of interest based on a region in which the object is detected; and a process of determining whether the object is exhibiting a predetermined type of behavior based on an area of an overlapping region between the detected object region and the virtual region of interest.

### BRIEF DESCRIPTION OF THE DRAWINGS

FIG. 1 is a block diagram schematically illustrating an exemplary system to which the present disclosure may be applied.

FIGS. 2 to 4 are diagrams showing various examples of virtual regions of interest generated according to various embodiments of the present disclosure.

FIG. 5 is a diagram illustrating an example of defining a virtual region of interest for each frame according to an embodiment of the present disclosure.

FIG. 6 is a diagram illustrating an example of defining a virtual region of interest for each frame according to another embodiment of the present disclosure.

FIG. 7 is a flowchart illustrating a behavior recognition method according to an embodiment of the present disclosure.

FIG. 8 is a block diagram schematically illustrating an exemplary computing device that may be used to implement apparatuses and methods described in the present disclosure.

### DETAILED DESCRIPTION

The present disclosure may provide a method and apparatus capable of recognizing an object's behavior in a rule-based manner by utilizing a mutual positional relationship between a virtual region of interest adaptively defined for an individual object and an object.

Features of the present disclosure are not limited to the aforementioned features, and other features not described above may be evidently understood by a person having ordinary skill in the art from the following description.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

In describing the components of an embodiment according to the present disclosure terms such as first, second, i), ii), a), b), etc., may be used. Such terms are used solely to differentiate one component from the other but not to imply or suggest the substances, order, or sequence of the components. Throughout this specification, when a part ‘includes’ or ‘comprises’ a component, the part is intended to further include other components, unless specifically stated otherwise.

The following detailed description, together with the accompanying drawings, is intended to describe example embodiments of the present disclosure, and is not intended to represent the only embodiments in which the present disclosure may be practiced.

In the present disclosure, the term “image” may be used to encompass both still images and videos.

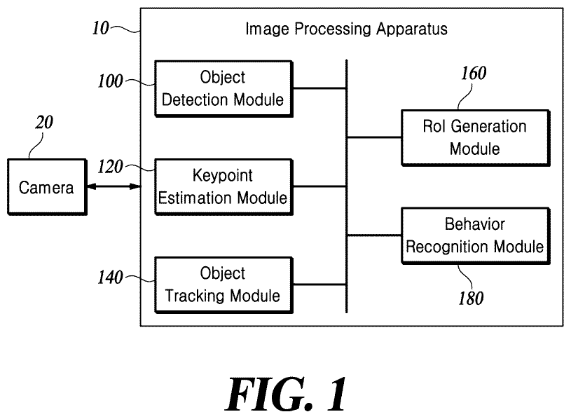

FIG. 1 is a block diagram schematically illustrating an exemplary system to which the present disclosure may be applied.

An image processing apparatus 10 may perform inference on an image acquired from a camera 20. The image processing apparatus 10 may recognize the behavior of one or more objects in the image and/or recognize a situation represented in the image. The image processing apparatus 10 may recognize the behavior of the object by analyzing a mutual positional relationship between the object and a floor surface on which the object is located, based on the image.

In the image, the floor surface may be identified based on a region of interest. For example, when the camera 20 is installed in a confined space, such as an indoor area (e.g., an elevator), where the floor and wall surfaces may be distinguished within the image, the floor surface may be identified based on the region of interest manually designated by a user in advance. However, when the camera 20 is installed in a space where it is difficult to specify the floor surface (e.g., in a large indoor or outdoor space relative to the field of view of the camera 20), the region of interest may not be predetermined in advance. For recognizing the behavior in a general space that is not limited to the confined area, the image processing apparatus 10 adaptively generates the virtual region of interest according to the object, and recognizes a falling behavior of the object by utilizing a mutual positional relationship between the object and the virtual region of interest.

To this end, the image processing apparatus 10 may include all or some of an object detection module 100, a keypoint estimation module 120, an object tracking module 140, an ROI generation module 160, and a behavior recognition module 180. It should be understood that all the blocks shown in FIG. 1 are not essential components, and some blocks may be added, modified, or omitted in other embodiments. Meanwhile, the components shown in FIG. 1 represent functionally distinct elements, and at least one of the components may be implemented in an integrated form with another component in an actual physical environment.

The object detection module 100 may detect a predetermined type of object from the image. Here, the predetermined type of object may be, for example, a person. The object detection module 100 may detect a bounding box surrounding the object. Here, one bounding box may include at least one object. The object detection module 100 may detect a plurality of bounding boxes, each surrounding one of a plurality of objects of the same type. Detecting the bounding box may include estimating two or more combinations among an upper-left coordinate of the bounding box, a lower-right coordinate of the bounding box, a center coordinate of the bounding box, and/or a size (width and height) of the bounding box, for example.

The keypoint estimation module 120 may estimate positions of keypoints corresponding to the object from the image. The keypoint may also be referred to as a landmark or joint. In one example, the keypoint estimation module 120 may receive an image and output coordinates of keypoints of any objects. In another example, the keypoint estimation module 120 may receive an image in which a portion where a specific object is detected is cropped, and output coordinates of one or more keypoints extracted for the corresponding object. In still another example, the keypoint estimation module 120 may receive the image and the coordinates of the bounding box as inputs, and output coordinates of one or more keypoints extracted for the corresponding object. The keypoint estimation module 120 may estimate, together with the coordinates of one or more keypoints, a confidence score indicating the probability that each keypoint is located at the corresponding coordinate.

The object tracking module 140 may track the object appearing in the image across a plurality of frames and identify objects having the same identity. For example, among the bounding boxes detected in the plurality of frames, the object tracking module 140 may assign the same identifier to bounding boxes surrounding objects having the same identity.

Various learning-based and/or rule-based algorithms may be employed for object detection, pose estimation, and object tracking, and the present disclosure is not limited thereto in any particular manner.

The ROI generation module 160 may generate a virtual region of interest based on an object region (i.e., bounding box) in which the object is detected in the image. The ROI generation module 160 may adaptively change the size and position of the virtual region of interest according to the size and position of the object appearing in the image.

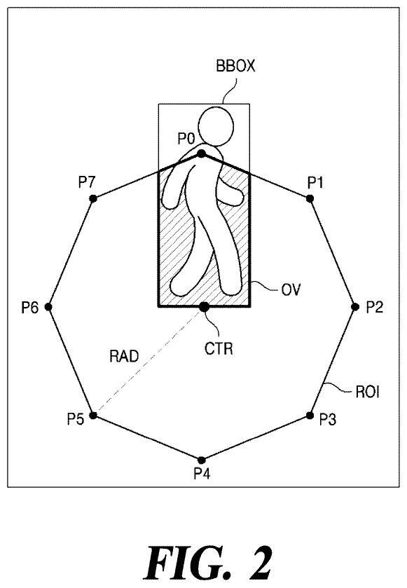

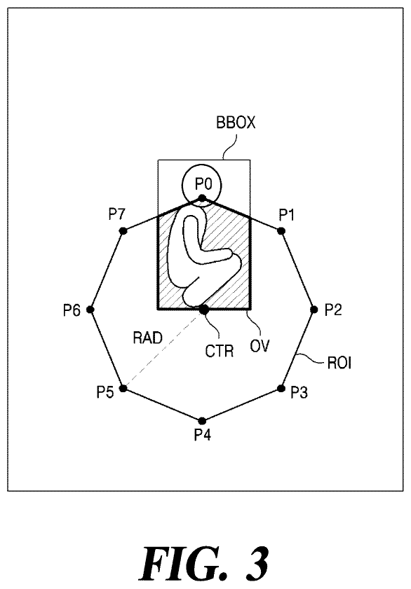

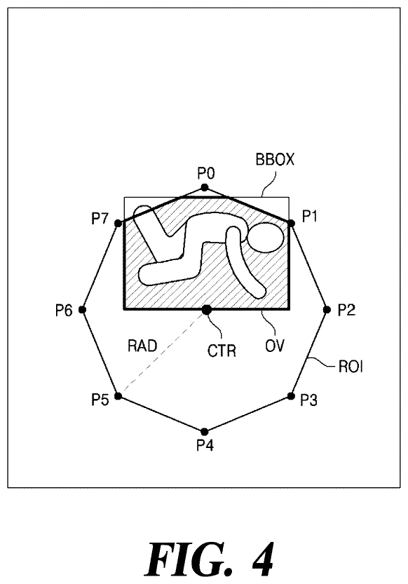

FIGS. 2 to 4 are diagrams showing various examples of virtual regions of interest generated according to various embodiments of the present disclosure. FIG. 2 shows an example of a virtual region of interest that may be generated in a standing case of an object, FIG. 3 shows an example of a virtual region of interest that may be generated in a squatting case of the object, and FIG. 4 shows an example of a virtual region of interest that may be generated in a lying case of the object.

The ROI generation module 160 may generate the virtual region of interest having, as its center, a point where the object contacts the floor surface. The ROI generation module 160 may regard a point within the object region BBOX as the point where the object contacts the floor surface.

In one example, the ROI generation module 160 may define a midpoint of a bottom side of the object region BBOX as a center position CTR of the virtual region of interest ROI. When the upper-left coordinate and the lower-right coordinate of the object region BBOX are denoted as (x1, y1) and (x2, y2), respectively, the center position CTR of the virtual region of interest ROI may be calculated as shown in Equation 1.

$$CTR = ( \frac{x 1 + x 2}{2} , y 2 ) \qquad [ Equation 1 ]$$

In another example, the ROI generation module 160 may define, as the center position CTR of the virtual region of interest ROI, either a position where a keypoint corresponding to a specific body part (e.g., a heel or an ankle) is extracted, or a perpendicular foot drawn from that position to the bottom side of the object region BBOX. For example, when the coordinates of the position where a specific keypoint is extracted are denoted as (x3, y3), the center position CTR of the virtual region of interest ROI may be set to (x3, y3) or (x3, y2).

The ROI generation module 160 may determine the size of the virtual region of interest ROI based on the length of the long side of the object region BBOX. For example, the distance between the center position CTR and at least one vertex of the virtual region of interest ROI may be calculated as shown in Equation 2.

$$RAD = α \cdot max ( W , H ) \qquad [ Equation 2 ]$$

Here, W and H respectively represent the width and height of the object region BBOX, and a represents a coefficient for adjusting the size of the virtual region of interest according to the size of the object. For example, a may be set to 0.75, but is not limited thereto.

In this manner, by adjusting the size of the virtual region of interest ROI based on the length of the long side of the object region BBOX, the size of the virtual region of interest ROI may flexibly change during the process in which the object falls. In addition, a high overlap ratio between the object region BBOX of a laterally lying object and the virtual region of interest ROI can be ensured.

For computational efficiency, the ROI generation module 160 may generate the virtual region of interest ROI having the shape of a convex polygon. For example, the virtual region of interest ROI may be a convex regular polygonal region inscribed in a predetermined circle. The ROI generation module 160 may generate a circle having, as its center and radius, the center position CTR determined according to Equations 1 and the length RAD determined according to Equation 2, respectively, and then may sample a plurality of points P0 to P7 on the circumference at equal intervals. The ROI generation module 160 may generate the virtual region of interest ROI having the sampled points as its vertices.

The position and/or size of the virtual region of interest may be updated on a frame-by-frame basis, or may be fixed to a value defined in a specific frame according to a predetermined rule.

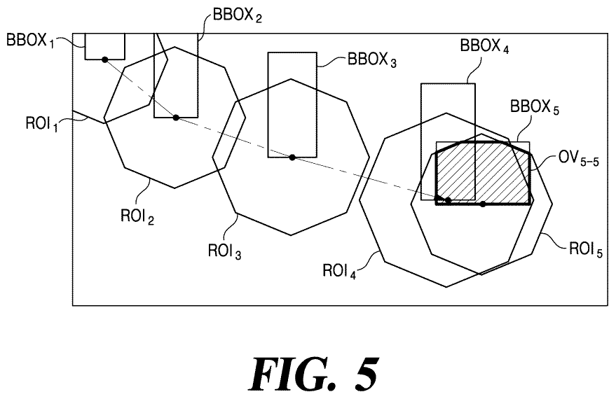

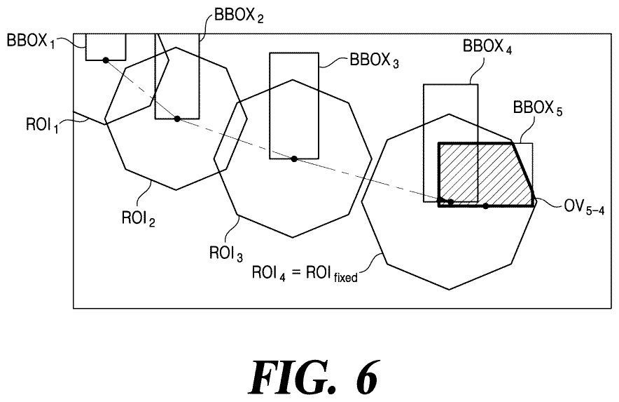

FIG. 5 is a diagram illustrating an example of defining a virtual region of interest for each frame according to an embodiment of the present disclosure. FIG. 6 is a diagram illustrating an example of defining a virtual region of interest for each frame according to another embodiment of the present disclosure. FIGS. 5 and 6 illustrate, in an overlapping manner, object regions BBOX₁ to BBOX₅ in which the object having the same identity is detected across a plurality of frames, and corresponding virtual regions of interest ROI₁ to ROI₅. Although FIGS. 5 and 6 depict the plurality of frames as having a relatively long time interval (i.e., a small FPS (Frame Per Second)), this is provided for ease of identification of the drawings, and the present disclosure is not limited thereto.

In one example, as shown in FIG. 5, the ROI generation module 160 may individually generate the virtual region of interest ROI for each frame. That is, the size and position of a virtual region of interest (ROI_{K}, where K is a natural number) in a K-th frame may be determined by an object region BBOX_{K} of the corresponding frame. In a video, the virtual region of interest ROI_{K} moves along with the movement of the object, and as the object approaches the camera 20, the size of the virtual region of interest ROI_{K} increases. Furthermore, as the pose of the object changes, the position and/or size of the virtual region of interest ROI_{K} may adaptively vary.

In another example, as shown in FIG. 6, the ROI generation module 160 may identically apply the position and/or size of a virtual region of interest ROI_{fixed} defined in a specific frame to subsequent frames.

The ROI generation module 160 may identify a timing at which to fix the virtual region of interest ROI_{fixed} based on a change pattern of the detected object regions BBOX₁ to BBOX₅ between the plurality of frames.

In one example, the ROI generation module 160 may identify a timing at which to fix the virtual region of interest ROI_{fixed} based on changes in the aspect ratio of the object regions BBOX₁ to BBOX₅. Table 1 illustrates the aspect ratios of the object regions shown in FIGS. 2 to 4.

TABLE 1

| | standing case | squatting case | lying case |
|---|---|---|---|
| Aspect ratio | 2.0 | 1.2 | 0.7 to 0.5 |

As shown in Table 1, the aspect ratio of the object region surrounding the object varies depending on the pose of the object. Thus, when the pose of the object changes significantly between the plurality of frames, the aspect ratios of the object regions BBOX₁ to BBOX₅ also change abruptly. In consideration of these characteristics, when the aspect ratio of the object region BBOX_{K} in a specific frame becomes equal to or less than a predetermined threshold aspect ratio, the ROI generation module 160 may maintain a virtual region of interest ROI_{K-1} generated in an immediately preceding frame. The threshold aspect ratio may be preset by a user or may be adaptively determined based on statistical values of the aspect ratios of the object regions BBOX₁ to BBOX_{K-1} in preceding frames. For example, when the aspect ratio of the object region BBOX₅ in a fifth frame sharply decreases (e.g., by 30% or more compared to an average value), the ROI generation module 160 may maintain the position and/or size of a virtual region of interest ROI₄ generated in a fourth frame for a fifth frame and subsequent frames.

Additionally or alternatively, the ROI generation module 160 may identify a timing at which to fix the virtual region of interest ROI_{fixed} based on the movement distance or movement speed of the object regions BBOX₁ to BBOX₅ between a plurality of frames.

The behavior recognition module 180 may recognize an object's behavior based on a geometric relationship between the object region and the virtual region of interest. The behavior recognition module 180 may recognize that the object is in the lying state or is performing a lying motion, based on the geometric relationship within a single frame and/or changes in the geometric relationship between the plurality of frames.

The geometric relationship between the object region and the virtual region of interest may be defined based on an overlap ratio between the object region BBOX and the virtual region of interest ROI. Referring to FIGS. 2 to 4, compared to when the object is standing or squatting, the virtual region of interest ROI and the object region BBOX overlap relatively more when the object is lying down. Based on this, the behavior recognition module 180 may recognize the lying of the object based on the relative size of an overlapping region OV, which corresponds to the portion where the virtual region of interest ROI and the object region BBOX overlap.

To this end, the behavior recognition module 180 may calculate an area of the overlapping region OV using position coordinates of the object region BBOX and the virtual region of interest ROI. In this case, the virtual region of interest ROI may use either a virtual region of interest ROI_{K} generated in individual frames or the fixed virtual region of interest ROI_{fixed}. For example, in the example of FIG. 5, an overlapping region OV₅₋₅ corresponding to the fifth frame is calculated based on the object region BBOX₅ detected in the fifth frame and the virtual region of interest ROI₅ generated therefrom. In contrast, in the example of FIG. 6, an overlapping region OV₅₋₄ corresponding to the fifth frame is calculated based on the object region BBOX₅ detected in the fifth frame and the virtual region of interest ROI₄ generated in the fourth frame.

The behavior recognition module 180 may use IoH (Intersection over Human area), which is the ratio of the overlapping area OV to the object area BBOX, as an index for evaluating the relative size of the overlapping area OV. Here, the IoH may be expressed as shown in Equation 3.

$$I o H = \frac{area ( R O I ⋂ BBOX )}{area ( BBOX )} = \frac{area ( OV )}{area ( BBOX )} \qquad [ Equation 3 ]$$

In another example, the behavior recognition module 180 may use IoF (Intersection over Floor area), which represents a ratio of the overlapping region OV to the virtual region of interest ROI, as an index for evaluating the relative size of the overlapping region OV. Here, the IoF may be expressed as shown in Equation 4.

$$I o F = \frac{area ( R O I ⋂ BBOX )}{area ( R O I )} = \frac{area ( OV )}{area ( R O I )} \qquad [ Equation 4 ]$$

The behavior recognition module 180 may recognize that the object is in the lying state based on whether the IoH or IoF calculated in a specific frame falls within a predetermined numerical range. Here, the numerical range may be a value statistically derived from a plurality of pre-acquired images. For example, the behavior recognition module 180 may determine that the object is lying down when the IoH has a value between 0.7 and 1.0. In another example, to reduce the probability of misrecognition, the behavior recognition module 180 may use a combination of the condition for IoH and the condition for IoF. According to an embodiment, the numerical ranges for IoH and/or IoF may be dynamically adjusted depending on the installation environment of the camera. For example, when a large amount of data has been obtained for the environment in which the current camera is installed, the recognition performance may be further improved by applying numerical ranges suitable for the current environment using statistical values of the corresponding data.

The behavior recognition module 180 may recognize the lying motion of the object based on a time-dependent change pattern of IoH or IoF calculated for each of the plurality of frames. For example, as illustrated in Table 2, when the IoH increases and then remains at a high value between a predetermined number N of frames, it may be determined that the object is lying down.

TABLE 2

| | | | | | N- | | | | | | |
|---|---|---|---|---|---|---|---|---|---|---|---|
| Frame | 1 | 2 | 3 | . . . | 6 | N-5 | N-4 | N-3 | N-2 | N-1 | N |
| IoH | 0.4 | 0.5 | 0.6 | . . . | 0.6 | 0.7 | 0.7 | 0.8 | 0.9 | 0.9 | 0.9 |

When it is determined that the object lies down, the behavior recognition module 180 may generate an alarm. The alarm may be provided visually, audibly, and/or tactilely to a control officer monitoring a surveillance space, and/or may be transmitted to a server operated by an emergency response agency (e.g., a fire department).

As described above, the image processing apparatus 10 according to various embodiments of the present disclosure may recognize the behavior of the object based on an overlap ratio between an adaptively generated virtual region of interest and an object region for each object instance. It has been experimentally confirmed that, in a non-lying case where the object takes a pose such as standing, sitting, squatting, or kneeling, the IoH always has a value less than 0.7, whereas in the lying case, the IoH increases to a value exceeding 0.7 and approaching 1. Thus, even when the overlap ratio is used alone, the lying behavior can be effectively recognized, and, according to an embodiment, the recognition performance can be further improved by combining a behavior recognition result based on the overlap ratio with a behavior recognition result based on learning-based or other rule-based algorithms.

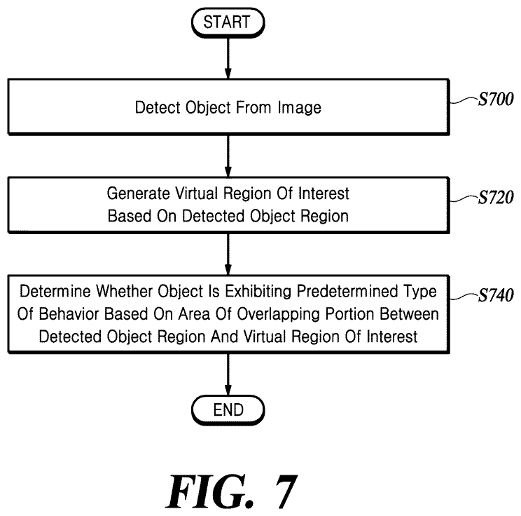

FIG. 7 is a flowchart illustrating a behavior recognition method according to an embodiment of the present disclosure.

The image processing apparatus 10 detects an object from an image in S700. The image processing apparatus 10 may detect a bounding box surrounding a predetermined type of object from the image. Detecting the bounding box may include acquiring the coordinate of at least one point that defines a position and/or a size of the bounding box.

The image processing apparatus 10 generates a virtual region of interest based on a detected object region, in S720. Here, the size and position of the virtual region of interest may be adaptively changed according to the size and position of the detected object region. For example, the image processing apparatus 10 may define a point within the region where the object is detected as a center position of the virtual region of interest. The image processing apparatus 10 may define a length from the center point to a boundary of the virtual region of interest, based on the length of a long side of the region where the object is detected. The image processing apparatus 10 may generate a convex polygonal region inscribed in a circle, which have the defined center position as its center and the defined length as its radius, as the virtual region of interest. For example, the image processing apparatus 10 may generate a regular polygonal region, which is inscribed in a circle having the defined center point and length as its center and radius, respectively, as the virtual region of interest.

The image processing apparatus 10 determines whether the object is exhibiting a predetermined type of behavior based on an area of an overlapping region, which is a region where the object detected region and the virtual region of interest overlap in S740. The image processing apparatus 10 may calculate a ratio of the overlapping region with respect to either the detected object region or the virtual region of interest, and recognize the behavior of the object based on the calculated ratio. The image processing apparatus 10 may recognize the behavior of the object independently for each frame, or may recognize the behavior of the object by combining the ratios calculated from a plurality of frames.

For example, the image processing apparatus 10 may determine whether the object lies down based on whether the ratio calculated in a specific frame falls within a predetermined numerical range. Here, the predetermined numerical range may be a value statistically derived based on a plurality of images obtained by a camera installed in a space of the same type as the camera that captures the image, or by a physically identical camera.

In another example, the image processing apparatus 10 may determine whether the object lies down based on a change in the ratio calculated across a plurality of frames. To this end, the image processing apparatus 10 may generate a frame-specific virtual region of interest based on the region in which the object is detected in each of the plurality of frames. When any target frame among the plurality of frames satisfies a predetermined rule, the image processing apparatus 10 may maintain at least one of the size and position of the virtual region of interest generated in the previous frame of the target frame in subsequent frames including the target frame. Here, the predetermined rule may be satisfied when the aspect ratio of the detected object region is less than a preset threshold aspect ratio. The threshold aspect ratio may be a predetermined value or may be adaptively defined based on the aspect ratio of the region in which objects with the same identity are detected in preceding frames.

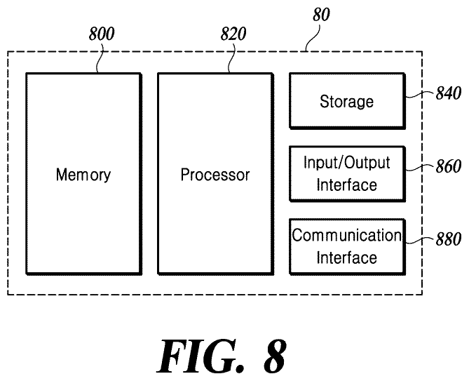

FIG. 8 is a block diagram schematically illustrating an exemplary computing device that may be used to implement apparatuses and methods described in the present disclosure.

The computing device 80 may include some or all of a memory 800, a processor 820, a storage 840, an input/output interface 860, and a communication interface 880. The computing device 80 may structurally and/or functionally include at least a portion of the image processing apparatus 10. The computing device 80 may be a stationary computing device such as a desktop computer or server, or a mobile computing device such as a laptop computer or smartphone. The computing device 80 may also be implemented as any specialized hardware accelerator capable of efficiently performing computations for an artificial intelligence model. For example, the computing device 80 may be implemented as a graphic processing unit (GPU), a tensor processing unit (TPU), or a neural processing unit (NPU).

The memory 800 may store a program that enables the processor 820 to perform the method or operation according to various embodiments of the present disclosure. For example, the program may include a plurality of instructions executable by the processor 820, and the method illustrated in FIG. 7 may be performed when the plurality of instructions are executed by the processor 820.

The memory 800 may be a single memory or a plurality of memories. In this case, information necessary for performing the method or operation according to various embodiments of the present disclosure may be stored in the single memory or distributed across the plurality of memories. When the memory 800 is configured with a plurality of memories, the plurality of memories may be physically separated.

The memory 800 may include at least one of a volatile memory and a non-volatile memory. The volatile memory may include static random access memory (SRAM) or dynamic random access memory (DRAM), and the non-volatile memory may include flash memory.

The processor 820 may include at least one core capable of executing at least one instruction. The processor 820 may execute instructions stored in the memory 800. The processor 820 may be a single processor or a plurality of processors.

The storage 840 retains stored data even when power supplied to the computing device 80 is interrupted. For example, the storage 840 may include the non-volatile memory, and may also include a storage medium such as magnetic tape, optical disks, or magnetic disks.

A program stored in the storage 840 may be loaded into the memory 800 before being executed by the processor 820. The storage 840 may store files written in a programming language, and a program generated from the files by a compiler or the like may be loaded into the memory 800. The storage 840 may store data to be processed by the processor 820 and/or data processed by the processor 820.

The input/output interface 860 may include an input device such as a keyboard or a mouse, and an output device such as a display device or a printer. A user may trigger the execution of a program by the processor 820 and/or check the processing result of the processor 820 through the input/output interface 860.

The communication interface 880 may provide access to an external network. For example, the computing device 80 may communicate with other devices (e.g., the camera 20) through the communication interface 880.

Each element of the device or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device, in addition, the computer-readable recording medium may further include a transitory medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

According to an embodiment of the present disclosure, an object's behavior can be recognized by utilizing a mutual positional relationship between a virtual region of interest adaptively defined for an individual object and an object.

According to an embodiment of the present disclosure, by automatically defining a virtual region of interest based on an object detection result, it is possible to recognize the behavior of an object without being limited by the environment in which a camera is installed.

Features of the present disclosure are not limited to the above-mentioned features, and other features will be clearly understood by those skilled in the art from the description.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity, and the scope of the technical idea of the present embodiments is not limited by the illustrations. The scope of protection of the present embodiment should be interpreted based on the following claims, and all technical ideas within the equivalent scope should be construed as being included within the scope of rights of the present embodiment.

What is claimed is:

1. A computer-implemented method for recognizing behavior of an object, the computer-implemented method comprising:
detecting an object from an image;
generating a virtual region of interest based on a region in which the object is detected; and
determining whether the object is exhibiting a predetermined type of behavior based on an area of an overlapping region between the detected object region and the virtual region of interest.

2. The computer-implemented method according to claim 1, wherein a size and a position of the virtual region of interest are adaptively changed according to the size and position of the detected object region

3. The computer-implemented method according to claim 1, wherein the generating comprises:
defining a point within the region in which the object is detected as a center position of the virtual region of interest; and
defining a length from the center position to a boundary of the virtual region of interest, based on a length of a long side of the region in which the object is detected.

4. The computer-implemented method according to claim 3, wherein the generating further comprises:
generating, as the virtual region of interest, a convex polygonal region inscribed in a circle, the circle having the defined center position as its center and the defined length as its radius.

5. The computer-implemented method according to claim 1, wherein the determining comprises calculating a ratio of the overlapping region with respect to either the detected object region or the virtual region of interest.

6. The computer-implemented method according to claim 5, wherein the determining comprises determining whether the object lies down, based on whether the calculated ratio falls within a predetermined numerical range.

7. The computer-implemented method according to claim 5, wherein the determining comprises determining whether the object lies down, based on a change in the ratio calculated across a plurality of frames.

8. The computer-implemented method according to claim 7, wherein the generating comprises generating the virtual region of interest, based on the region in which the object is detected in each of the plurality of frames, and,
wherein, based on a determination that a target frame among the plurality of frames satisfies a predetermined rule, at least one of a size and a position of the virtual region of interest generated in a previous frame of the target frame is maintained for the target frame.

9. The computer-implemented method according to claim 8, wherein the predetermined rule is that an aspect ratio of the detected object region is less than a preset threshold aspect ratio.

10. An apparatus comprising:
a memory configured to store instructions; and
at least one processor,
wherein the at least one processor executing the instructions configured to:
detect an object from an image;
generate a virtual region of interest based on a region in which the object is detected; and
determine whether the object is exhibiting a predetermined type of behavior based on an area of an overlapping region between the detected object region and the virtual region of interest.

11. The apparatus according to claim 10, wherein a size and a position of the virtual region of interest are adaptively changed according to the size and position of the detected object region

12. The apparatus according to claim 10, wherein the at least one processor executing the instructions further configured to:
define a point within the region in which the object is detected as a center position of the virtual region of interest; and
define a length from the center position to a boundary of the virtual region of interest, based on a length of a long side of the region in which the object is detected.

13. The apparatus according to claim 12, wherein the at least one processor executing the instructions further configured to:
generate, as the virtual region of interest, a convex polygonal region inscribed in a circle, the circle having the defined center position as its center and the defined length as its radius.

14. The apparatus according to claim 10, wherein the at least one processor executing the instructions further configured to:
calculate a ratio of the overlapping region with respect to either the detected object region or the virtual region of interest.

15. The apparatus according to claim 14, wherein the at least one processor executing the instructions further configured to:
determine whether the object lies down, based on whether the calculated ratio falls within a predetermined numerical range.

16. The apparatus according to claim 14, wherein the at least one processor executing the instructions further configured to:
determine whether the object lies down, based on a change in the ratio calculated across a plurality of frames.

17. The apparatus according to claim 14, wherein the at least one processor executing the instructions further configured to generate the virtual region of interest, based on the region in which the object is detected in each of the plurality of frames, and,
wherein, based on a determination that a target frame among the plurality of frames satisfies a predetermined rule, at least one of a size and a position of the virtual region of interest generated in a previous frame of the target frame is maintained for the target frame.

18. The apparatus according to claim 17, wherein the predetermined rule is that an aspect ratio of the detected object region is less than a preset threshold aspect ratio.

19. A non-transitory computer-readable recording medium storing instructions that, when executed by a computer, cause the computer to execute:
a process of detecting an object from an image;
a process of generating a virtual region of interest based on a region in which the object is detected; and
a process of determining whether the object is exhibiting a predetermined type of behavior based on an area of an overlapping region between the detected object region and the virtual region of interest.
